(19) United States
(12) Patent Application Publication
(10) Pub. No.: US 2023/0062923 A1
(43) Pub. Date: Mar. 2, 2023

(54) AUTOMATIC ENTRY-EXIT SYSTEM, AUTOMATIC ENTRY-EXIT METHOD, AND STORAGE MEDIUM

(71) Applicant: TOYOTA JIDOSHA KABUSHIKI KAISHA, Toyota-shi (JP)

(72) Inventors: Satoshi OMI, Ebina-shi (JP); Takanori IMAZU, Susono-shi (JP); Yoshiki FUKADA, Susono-shi (JP); Takashi HAYASHI, Mishima-shi (JP); Yuta KATAOKA, Tokyo (JP); Kohki BABA, Susono-shi (JP); Ryuji OKAMURA, Susono-shi (JP); Akihiro KUSUMOTO, Susono-shi (JP)

(21) Appl. No.: 17/809,404

(22) Filed: Jun. 28, 2022

(30) Foreign Application Priority Data
Aug. 27, 2021 (JP) 2021-138836

(51) Int. Cl. B60W 30/06; G08G 1/01

(52) U.S. Cl. CPC B60W 30/06; G08G 1/0133

(57) ABSTRACT

Provided is an automatic parking service causes a vehicle that has arrived at a platform to enter one parking space among a plurality of parking spaces by autonomous driving and that causes the vehicle parked in the parking space exit the platform by autonomous driving. A congestion degree of a platform requested to be used in an entry-exit time zone specified by a user that uses the automatic parking service is determined when an entry-exit request in which one platform among the plurality of platforms is used is received from the user. The use of another platform is proposed to the user when the congestion degree of the platform requested to be used is high, the other platform having a lower congestion degree than the platform requested to be used.

### CROSS-REFERENCE TO RELATED APPLICATION

This application claims priority to Japanese Patent Application No. 2021-138836 filed on Aug. 27, 2021, incorporated herein by reference in its entirety.

### BACKGROUND

### 1. Technical Field

The present disclosure relates to an automatic entry-exit system, an automatic entry-exit method, and a storage medium.

### 2. Description of Related Art

Known is an automatic entry-exit system including an entry-exit control server that controls entry and exit so as to provide an automatic parking service that causes a vehicle that has arrived at a platform to enter one parking space among a plurality of parking spaces by autonomous driving and that causes the vehicle parked in the parking space exit the platform by autonomous driving, in which the congestion degree of the platform is estimated, and at the exit time requested by the user of the automatic parking service, when the congestion degree of the platform is predicted to be a threshold or more, the system makes a proposal of changing the exit time to an exit time in which the congestion degree of the platform is the threshold or less to the user of the automatic parking service (for example, see Japanese Unexamined Patent Application Publication No. 2020-166631 (JP 2020-166631 A)).

### SUMMARY

However, there is a problem that simply proposing a change in the exit time is not sufficient to reduce the congestion at the platform.

According to the present disclosure, in an automatic entry-exit system comprising an entry-exit control server that controls entry and exit so as to provide an automatic parking service that causes a vehicle that has arrived at a platform to enter one parking space among a plurality of the parking spaces by autonomous driving and that causes the vehicle parked in the parking space to exit the platform by autonomous driving, the automatic entry-exit system includes a plurality of the platforms, and the entry-exit control server includes a congestion degree determination unit that determines a congestion degree of a platform requested to be used in an entry-exit time zone specified by a user that uses the automatic parking service, when an entry-exit request in which one platform among the plurality of the platforms is used is received from the user, and an alternative solution proposal unit that proposes use of another platform among the plurality of the platforms when the congestion degree of the platform requested to be used is high, the other platform having a lower congestion degree than the platform requested to be used. Further, according to the present disclosure, in an automatic entry-exit system comprising an entry-exit control server that controls entry and exit so as to provide an automatic parking service that causes a vehicle that has arrived at a platform to enter one parking space among a plurality of the parking spaces by autonomous driving and that causes the vehicle parked in the parking space to exit to the platform by autonomous driving, the entry-exit control server includes a congestion degree determination unit that determines, when exit requests specifying destinations in the same direction and the same exit time zone are received from a plurality of users that uses an automatic parking service and a ride share service, a congestion degree of the platform in the exit time zone for which the exit requests are received, and an alternative solution proposal unit that proposes carpooling to each of the users when the congestion degree of the platform is high. Further, according to the present disclosure, provided is an automatic entry-exit method that controls entry and exit so as to provide an automatic parking service that causes a vehicle that has arrived at a platform to enter one parking space among a plurality of the parking spaces by autonomous driving and that causes the vehicle parked in the parking space to exit to the platform by autonomous driving, in which the automatic entry-exit method determines a congestion degree of a platform requested to be used in an entry-exit time zone specified by a user that uses the automatic parking service, when an entry-exit request in which one platform among a plurality of the platforms is used is received from the user, and in which the automatic entry-exit method proposes use of another platform among the plurality of the platforms when the congestion degree of the platform requested to be used is high, the other platform having a lower congestion degree than the platform requested to be used. Further, according to the present disclosure, provided is a storage medium that stores a program for controlling entry and exit so as to provide an automatic parking service that causes a vehicle that has arrived at a platform to enter one parking space among a plurality of the parking spaces by autonomous driving and that causes the vehicle parked in the parking space to exit to the platform by autonomous driving, in which the program causes a computer to function so as to determine a congestion degree of a platform requested to be used in an entry-exit time zone specified by a user that uses the automatic parking service, when an entry-exit request in which one platform among a plurality of the platforms is used is received from the user, and propose use of another platform among a plurality of the platforms when the congestion degree of the platform requested to be used is high, the other platform having a lower congestion degree than the platform requested to be used.

The congestion degree in entry and exit can be reduced.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram graphically illustrating an example of a road, a parking lot, and a platform;

FIG. 2 is a diagram graphically illustrating of another example of a road, a parking lot, and a platform;

FIG. 3 is a diagram graphically illustrating a vehicle;

FIG. 4 is a diagram graphically illustrating a parking lot control server;

FIG. 5 is a diagram graphically illustrating an example of an operation when starting autonomous driving;

FIG. 6 is a flowchart for performing a vehicle operation control;

FIG. 7 is a flowchart for managing and controlling entry and exit;

FIG. 8A is a diagram showing a list of congestion degrees;

FIG. 8B is a diagram showing a list of congestion degrees;

FIG. 9A is a diagram showing an example of the congestion degree;

FIG. 9B is a diagram showing an example of the congestion degree;

FIG. 10A is a diagram showing a data set for creating a congestion degree prediction model;

FIG. 10B is a diagram showing a data set for creating a congestion degree prediction model;

FIG. 11 is a diagram showing a neural network;

FIG. 12 is a flowchart for calculating the congestion degree;

FIG. 13 is a functional configuration diagram of the embodiment according to the present disclosure;

FIG. 14 is a flowchart of one embodiment for managing and controlling entry and exit;

FIG. 15 is a flowchart of another embodiment for managing and controlling entry and exit;

FIG. 16 is a flowchart of another embodiment for managing and controlling entry and exit;

FIG. 17 is a flowchart of yet another embodiment for managing and controlling entry and exit; and

FIG. 18 is a flowchart of yet another embodiment for managing and controlling entry and exit.

### DETAILED DESCRIPTION OF EMBODIMENTS

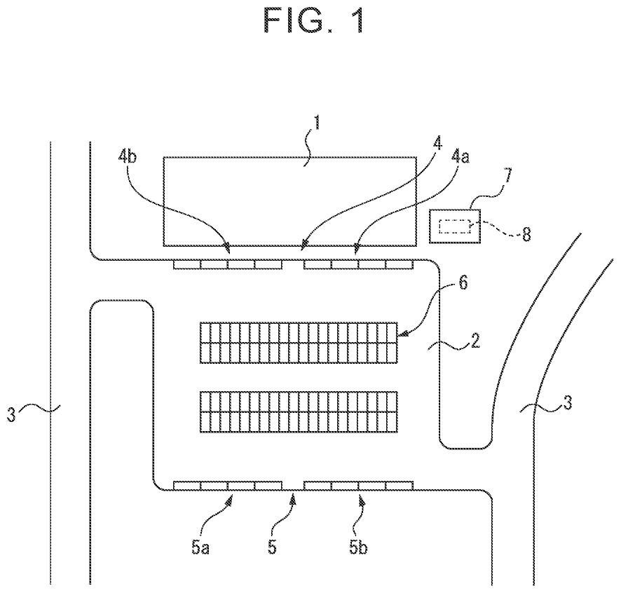

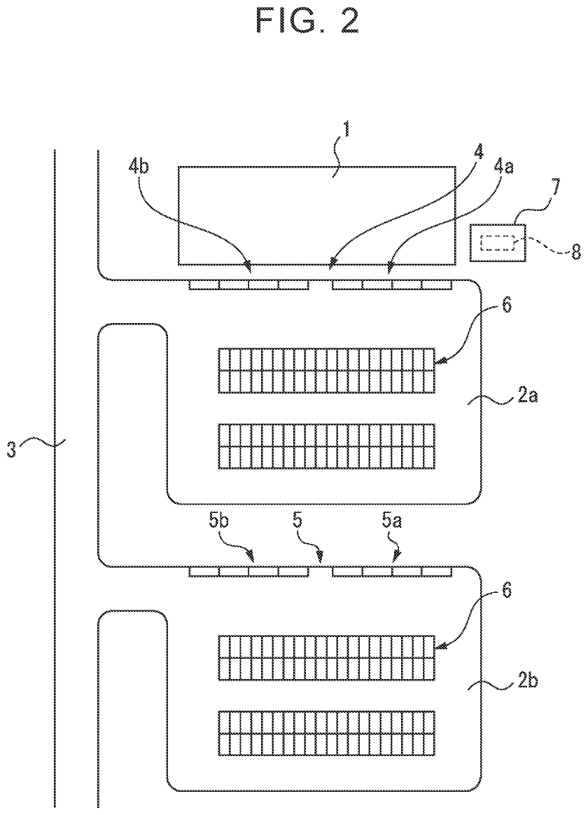

First, the environment to which the present disclosure is applied will be described with reference to FIGS. 1 and 2 that graphically illustrate two examples of a road, a parking lot, and a platform. Referring to FIG. 1 showing a first example, the numeral 1 indicates a facility such as a store or a restaurant, the numeral 2 indicates a parking lot that is juxtaposed with the facility 1, the numeral 3 indicates a road, the numeral 4 indicates a first platform, and the numeral 5 indicates a second platform. In the parking lot 2, an automatic parking service, that is, an auto-valet parking service is executed in which a vehicle arriving at the first platform 4 or the second platform 5 is made to enter one parking space 6 among a plurality of the parking spaces 6 by autonomous driving and in which the vehicle parked at the parking space 6 is made to exit to the first platform 4 or a second platform 5. In FIG. 1, 7 indicates a parking control facility that is juxtaposed with the facility 1, and an entry-exit control server 8 that manages and controls entry and exit is installed to provide an automatic parking service in the parking control facility 7.

On the other hand, in the example shown in FIG. 1, the first platform 4 is composed of a boarding place 4a and an alighting place 4b, and the second platform 5 is also composed of a boarding place 5a and an alighting place 5b. In this case, the boarding places 4a and 5a and the alighting places 4b and 5b can be installed independently in this way, or the boarding places 4a and 5a and the alighting places 4b and 5b can be integrated and be installed as the platforms 4 and 5. Further, in the example shown in FIG. 1, two platforms 4 and 5 are installed, but three or more platforms 4 and 5 can also be installed. Which platform 4 or 5 is used is determined based on the request of a user who uses the automatic parking service.

Next, referring to FIG. 2 showing the second example, in this example, the parking lot 2 that is juxtaposed with the facility 1 is composed of the first parking lot 2a and the second parking lot 2b. Further, in the example shown in FIG. 2, the first platform 4 is installed in the first parking lot 2a, and the second platform 5 is installed in the second parking lot 2b. Further, also in the example shown in FIG. 2, the first platform 4 is composed of the boarding place 4a and the alighting place 4b, and the second platform 5 is composed of the boarding place 5a and the alighting place 5b. In this case, the boarding places 4a and 5a and the alighting places 4b and 5b can be installed independently in this way, or the boarding places 4a and 5a and the alighting places 4b and 5b can be integrated and be installed as the platforms 4 and 5. Further, in the example shown in FIG. 2, two or more platforms 4 and 5 can be installed for each of the parking lots 2a and 2b. In order to use the automatic parking service, the vehicle must have an autonomous driving function.

Next, an example of the procedure for using the automatic parking service will be briefly described by taking the case of going to facility 1 as an example. When using the parking lots 2, 2a, and 2b to go to the facility 1, the user who uses the automatic parking service first determines the entry-exit time zone of the parking lots 2, 2a, and 2b and the platforms 4 and 5 that the user wants to use when entering and exiting. When the user determines the entry-exit time zone and the platforms 4 and 5 that the user wants to use when entering and exiting, the user sends the entry-exit time zone specified by the user and the platform that the user wants to use, that is, the platforms 4 and 5 requested to be used by the user (hereinafter, referred to as the platforms requested to be used), from a mobile terminal owned by the user to the entry-exit control server 8 via a communication network, for example. When the entry-exit time zone specified by the user and the platforms 4 and 5 that are requested to be used are available, the user's mobile terminal is notified to that effect. After that, the user moves the vehicle to the platforms 4 and 5 that are requested to be used, shortly before the entry time specified by the user. In this case, the user can move the vehicle to the platforms 4 and 5 that are requested to be used by manual driving or autonomous driving, but hereinafter, a case in which the vehicle is moved to the platforms 4 and 5 that are requested to be used by autonomous driving will be described as an example.

When the vehicle arrives at the platforms 4 and 5 that are requested to be used, by autonomous driving, the user gets off the vehicle and sends the entry request from the user's mobile terminal to the entry-exit control server 8. Upon receiving the entry request, the entry-exit control server 8 sends a travel route to the empty parking space 6 to the vehicle, whereby the vehicle is made to travel along the sent travel route to the empty parking space 6 by autonomous driving. Next, the user goes to the platforms 4 and 5 that are requested to be used, shortly before the exit time specified by the user, and sends the exit request from the user's mobile terminal to the entry-exit control server 8. Upon receiving the exit request, the entry-exit control server 8 sends to the vehicle, the travel route from the parking space 6 in which the vehicle is currently parked to the platforms 4 and 5 that are requested by the user, whereby the vehicle is made to travel from the parking space 6 in which the vehicle is currently parked to the platforms 4 and 5 that are requested to be used, along the sent travel route by autonomous driving. When the vehicle reaches the platforms 4 and 5 that are requested to be used, the user gets into the vehicle and then the vehicle is moved toward the next destination.

A large number of surveillance cameras are installed in each of the parking lots 2, 2a, 2b to monitor the usage status of each of the parking spaces 6, and image signals taken by these surveillance cameras are sent to the entry-exit control server 8. In the entry-exit control server 8, the usage status of each of the parking spaces 6 is discriminated from the image signals taken by each of the surveillance cameras. Further, in the embodiment according to the present disclosure, a large number of surveillance cameras are installed in each of the platforms 4 and 5 in order to monitor the usage status, that is, the congestion degree of each of the platforms 4 and 5. The image signals taken by the cameras are sent to the entry-exit control server 8. In the entry-exit control server 8, the usage status, that is, the congestion degree of each of the platforms 4 and 5 is discriminated from the image signals taken by each of the surveillance cameras.

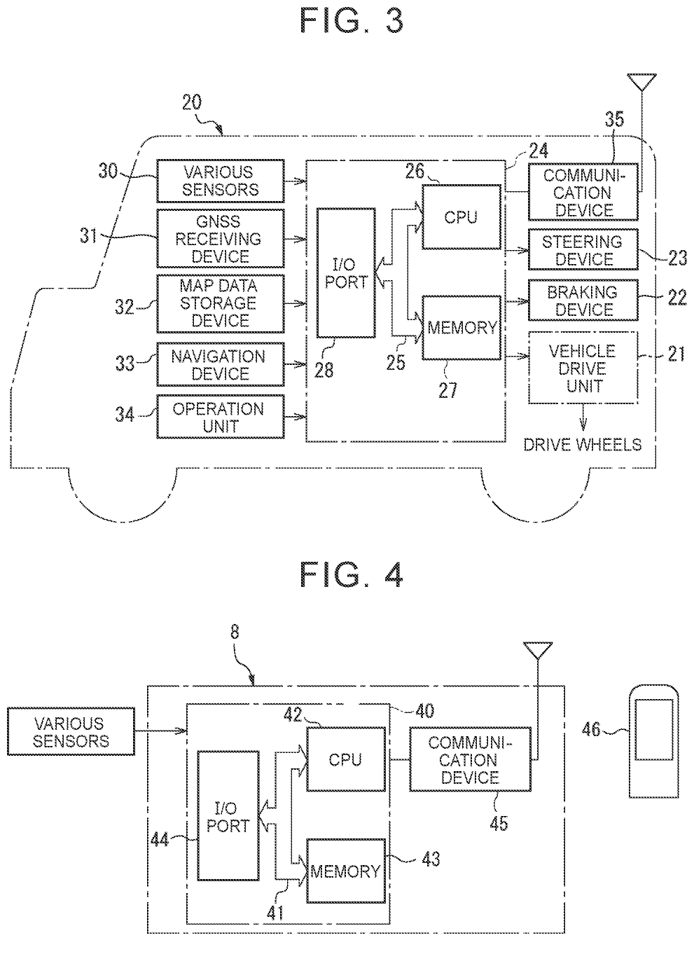

FIG. 3 graphically illustrates an example of a vehicle 20 suitable for using an automatic parking service. Referring to FIG. 3, the numeral 21 indicates a vehicle drive unit for applying a driving force to drive wheels of the vehicle 20, the numeral 22 indicates a braking device for braking the vehicle 20, the numeral 23 indicates a steering device for steering the vehicle 20, and the numeral 24 indicates an electronic control unit mounted in the vehicle 20. As shown in FIG. 3, the electronic control unit 24 is composed of a digital computer, and includes a central processing unit (CPU: microprocessor) 26, a memory 27 composed of a read-only memory (ROM) and a random access memory (RAM), and an input/output port 28 that are connected to each other by a bidirectional bus 25.

On the other hand, as shown in FIG. 3, the vehicle 20 is provided with various sensors 30 necessary for the vehicle 20 to perform autonomous driving, that is, a sensor for detecting the state of the vehicle 20 and a sensor for detecting the periphery of the vehicle 20. In this case, an acceleration sensor, a speed sensor, and an azimuth angle sensor are used as the sensor that detects the state of the vehicle 20, and a camera for capturing images of the front of the vehicle 20 or the like, light detection and ranging (LIDAR), a radar, or the like are used as the sensor that detects the periphery of the vehicle 20. Further, the vehicle 20 is provided with a Global Navigation Satellite System (GNSS) receiving device 31, a map data storage device 32, a navigation device 33, and an operation unit 34 for performing various operations. The GNSS receiving device 31 can detect the current position of the vehicle 20 (for example, the latitude and longitude of the vehicle 20) based on the information obtained from a plurality of artificial satellites. Thus, the current position of the vehicle 20 can be acquired by the GNSS receiving device 31. As the GNSS receiving device 31, for example, a global positioning system (GPS) receiving device is used.

On the other hand, the map data storage device 32 stores map data and the like necessary for the vehicle 20 to perform autonomous driving. Further, an operation unit 34 is provided with an operation panel necessary for autonomous driving or the like, and when a destination is input on the operation panel, the travel route of the vehicle 20 is searched using the navigation device 33. These various sensors 30, the GNSS receiving device 31, the map data storage device 32, the navigation device 33, and the operation unit 34 are connected to the electronic control unit 24.

On the other hand, FIG. 4 shows the parking control server 8 installed in the parking control facility 7 in FIGS. 1 and 2. As shown in FIG. 4, an electronic control unit 40 is installed in the parking control server 8. The electronic control unit 40 is composed of a digital computer, and includes a central processing unit (CPU) (microprocessor) 42, a memory 43 composed of a read-only memory (ROM) and a random access memory (RAM), and an input/output port 44 that are connected to each other by a bidirectional bus 41. A communication device 45 for communicating with the vehicle 20 is also installed in the parking control server 8. The vehicle 20 is equipped with a communication device 35 for communicating with the parking control server 8. Further, FIG. 4 shows a mobile terminal 46 that is owned by a user who uses the automatic parking service, and that is capable of communicating with the communication device 45 of the parking control server 8 via a communication network.

Referring to FIG. 3, in the embodiment according to the present disclosure, the vehicle drive unit 21 is composed of an electric motor driven by a secondary battery or an electric motor driven by a fuel cell. Driving of the drive wheels is controlled by the electric motor described above in accordance with an output signal from the electronic control unit 24. Further, the braking control of the vehicle 20 is executed by the braking device 22 in accordance with the output signal from the electronic control unit 24. The steering control of the vehicle 20 is executed by the steering device 23 in accordance with the output signal from the electronic control unit 24.

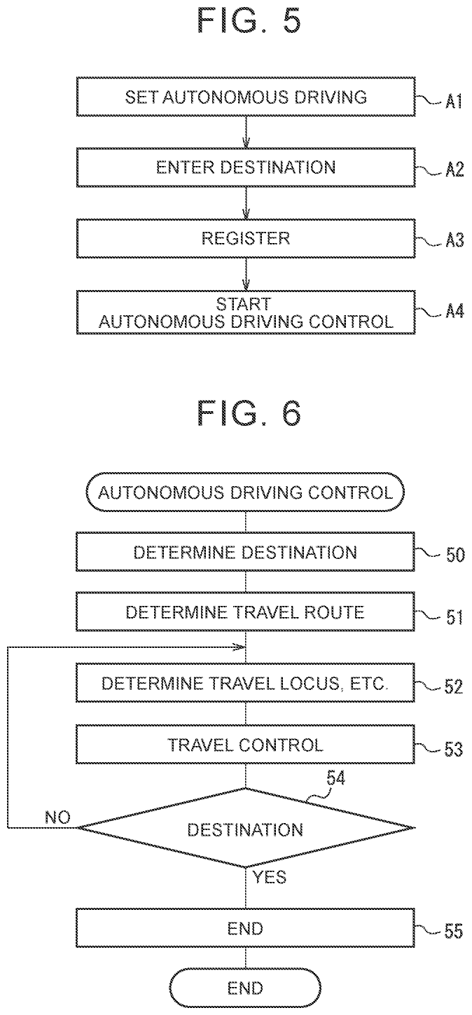

Next, an outline of autonomous driving by the vehicle 20 will be described with reference to FIGS. 3, 5, and 6. FIG. 5 shows an example of operations when starting autonomous driving by the vehicle 20, and these operations are performed on the operation panel of the operation unit 34. In the example shown in FIG. 5, first, as shown in A1 of FIG. 5, an autonomous driving setting operation for setting the driving mode of the vehicle 20 to autonomous driving is performed. This autonomous driving setting operation is executed, for example, by touching an item “autonomous driving setting” displayed on the operation panel of the operation unit 34. When the item “autonomous driving setting” displayed on the operation panel of the operation unit 34 is touched, a destination input screen appears on the operation panel of the operation unit 34, and as shown in A2 of FIG. 5, the destination is entered in this input screen. In this case, for example, the first platform 4 of the facility 1 shown in FIG. 1 is input as the destination.

When the input of the destination is completed, the destination is registered as shown in A3 of FIG. 5. This registration of the destination is executed, for example, by touching an item “registration” displayed on the operation panel of the operation unit 34. When the destination is registered, the input destination is stored in the memory 27 of the electronic control unit 24 mounted on the vehicle 20. When the destination is registered, the autonomous driving control of the vehicle 20 is started as shown in A4 of FIG. 5. FIG. 6 shows a routine for performing autonomous driving control of the vehicle 20, and this routine is repeatedly executed in the CPU 26 of the electronic control unit 24 mounted on the vehicle 20.

Referring to FIG. 6, first, in step 50, the destination stored in the memory 27 of the electronic control unit 24, for example, the first platform 4 of the facility 1 shown in FIG. 1 is set as the destination. When the destination is determined, the process proceeds to step 51, and the navigation device 33 determines the travel route of the vehicle 20 from the current position to the next destination based on the determined destination and the current position of the vehicle 20 acquired by the GNSS receiving device 31. Next, in step 52, the travel locus and the travel speed of the vehicle 20 are determined so as not to contact other vehicles and pedestrians based on the detection result of a sensor such as a camera for capturing an image of the front or the like of the vehicle 20, a LIDAR, and a radar.

Next, in step 53, the travel control of the vehicle 20 is performed in accordance with the determined traveling locus and traveling speed. Next, in step 54, it is discriminated whether the vehicle 20 has arrived at the destination determined in step 50. When it is discriminated that the vehicle 20 has not reached the destination, the process returns to step 52, and the autonomous driving of the vehicle 20 is continued. On the other hand, when it is discriminated in step 54 that the vehicle 20 has reached the destination, the process proceeds to step 55, and the autonomous driving of the vehicle 20 is temporarily terminated.

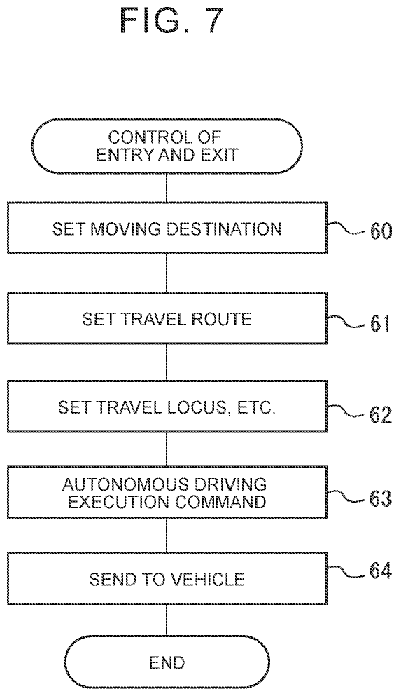

When the vehicle 20 arrives at the destination, for example, the first platform 4 of the facility 1 shown in FIG. 1, the user sends an entry request from the user's mobile terminal 46 to the entry-exit control server 8. Upon receiving the entry request, the entry-exit control server 8 executes entry-exit control for making the vehicle 20 travel to the empty parking space 6 by autonomous driving. FIG. 7 shows an entry-exit control routine executed by the electronic control unit 40 of the entry-exit control server 8 in order to execute the entry-exit control.

Referring to FIG. 7, first, in step 60, the moving destination of the vehicle 20 is set. When the entry-exit control server 8 receives the entry request, the empty parking space 6 is set as the moving destination of the vehicle 20, from among the large number of parking spaces 6. When the moving destination is set, the process proceeds to step 61, and a travel route from the first platform 4 to the empty parking space 6 is set. Next, in step 62, the traveling locus and traveling speed of the vehicle 20 that does not come into contact with other vehicles or structures are determined. Next, in step 63, an autonomous driving execution command for the vehicle 20 is issued, and then in step 64, the empty parking space 6, the travel route, the travel locus, and the travel speed, and the autonomous driving execution command that are set are sent from the entry-exit control server 8 to vehicle 20.

When the vehicle 20 receives the set empty parking space 6, travel route, travel locus, travel speed, and automatic driving execution command, in the automatic driving control routine of the vehicle 20 shown in FIG. 6, in step 50, the set empty parking space 6 is determined as the destination, in step 51, the set travel route is determined as the travel route, and in step 52, the set travel locus and travel speed are determined as the traveling locus and traveling speed. Next, in steps 53 and 54, the travel control of the vehicle 20 is performed according to the determined travel locus and travel speed until the vehicle 20 reaches the set empty parking space 6. In this way, the entry process of the vehicle 20 is performed.

On the other hand, when the user wants to exit, shortly before the exit time specified by the user, the user goes to the platforms 4 and 5 that are requested to be used, for example, the first platform 4 of the facility 1, and sends the exit request from the user's mobile terminal 46 to the entry-exit control server 8. Upon receiving the exit request, the entry-exit control server 8 executes the entry-exit control for making the vehicle 20 travel from the parking space 6 in which the vehicle 20 is currently parked to the first platform 4 desired by the user by autonomous driving. This entry-exit control is also executed using the entry-exit control routine shown in FIG. 7. However, in this case, in step 60 of FIG. 7, the first platform 4 of the facility 1 is set as the moving destination of the vehicle 20, in step 61, the traveling route from the parking space 6 in which the vehicle 20 is currently parked to the first platform 4 is set, in step 62, the traveling locus and traveling speed of the vehicle 20 that does not come into contact with other vehicles or structures is set, in step 63, the autonomous driving execution command for the vehicle 20 is issued, in step 64, the set moving destination, travel route, travel locus, travel speed, and automatic driving execution command are transmitted from the entry-exit control server 8 to the vehicle 20.

When the vehicle 20 receives the set moving destination, travel route, travel locus, travel speed, and the autonomous driving execution command, in the automatic driving control routine of the vehicle 20 shown in FIG. 6, in step 50, the set moving destination, for example, the first platform 4 of the facility 1 is determined as the destination, in step 51, the set travel route is determined as the travel route, and in step 52, the set travel locus and travel speed are determined as the travel locus and travel speed. Next, in steps 53 and 54, the travel control of the vehicle 20 is performed in accordance with the determined travel locus and travel speed until the vehicle 20 reaches the first platform 4 of the facility 1. In this way, the exit process of the vehicle 20 is performed.

By the way, when using the automatic parking service, it is often necessary for the user of the automatic parking service to make a reservation of the entry-exit time zone of the parking lot that is desired. In this case, in the parking lot that provides the automatic parking service, since the user gets on and off at the platform juxtaposed with the parking lot at the time of entering and exiting of the vehicle 20, whether the vehicle 20 can entered and exit at the desired time zone will depend on the congestion degree of the platform at the desired time zone. That is, when the congestion degree of the platform is low in the desired time zone, the user can make the vehicle 20 enter and exit in the desired time zone, and when the congestion degree of the platform is high in the desired time zone, it becomes impossible for the user to make the vehicle 20 enter and exit in the desired time zone. Thus, it is necessary to predict the congestion degree at the platform.

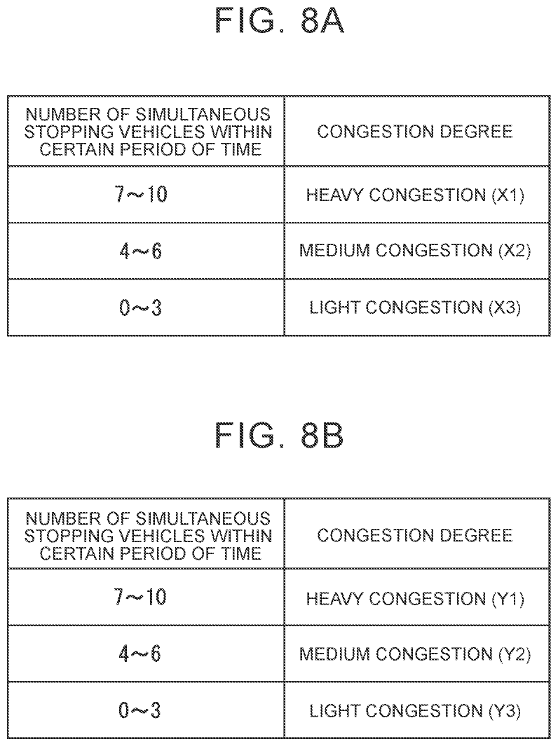

Therefore, next, an example of a congestion degree prediction method for predicting the congestion degree of the platform will be described with reference to FIGS. 8A to 12. As described above, in the embodiment according to the present disclosure, a large number of surveillance cameras are installed in each of the platforms 4 and 5 in order to monitor the congestion degree of each of the platforms 4 and 5. Based on the image signals captured by the surveillance cameras, the entry-exit control server 8 determines the congestion degree at each of the platforms 4 and 5. FIG. 8A shows an example of a criterion for determining the congestion degree of the platform 4 when 10 boarding and alighting vehicle stop spaces are installed in the platform 4. FIG. 8B shows an example of a criterion for determining the congestion degree of the platform 5 when 10 boarding and alighting vehicle stop spaces are installed in the platform 5.

In the example shown in FIG. 8A, the congestion degree is discriminated based the usage rate of the boarding and alighting vehicle stop space of the platform 4 within a fixed time, that is, an average value of the number of vehicles simultaneously stopped in the boarding and alighting vehicle stop space of the platform 4 within a fixed time, for example, 10 minutes. In this case, in the example shown in FIG. 8A, when the average value of the number of vehicles simultaneously stopped within a certain period of time is 0 to 3, the congestion degree is discriminated to a low congestion (X3), when the average value of the number of vehicles stopped simultaneously within a certain period of time is 4 to 6, the congestion degree is determined to be medium congestion (X2), and when the average value of the number of vehicles stopped simultaneously within a certain period of time is 7 to 10, the congestion degree is determined to be high congestion (X1).

On the other hand, in the example shown in FIG. 8B, similar to the example shown in FIG. 8A, the congestion degree is discriminated based the usage rate of the boarding and alighting vehicle stop space of the platform 5 within a fixed time, that is, an average value of the number of vehicles simultaneously stopped in the boarding and alighting vehicle stop space of the platform 5 within a fixed time, for example, 10 minutes. In this case, in the example shown in FIG. 8B, similar to the example shown in FIG. 8A, when the average value of the number of vehicles simultaneously stopped within a certain period of time is 0 to 3, the congestion degree is discriminated to a low congestion (Y3), when the average value of the number of vehicles stopped simultaneously within a certain period of time is 4 to 6, the congestion degree is determined to be medium congestion (Y2), and when the average value of the number of vehicles stopped simultaneously within a certain period of time is 7 to 10, the congestion degree is determined to be high congestion (Y1).

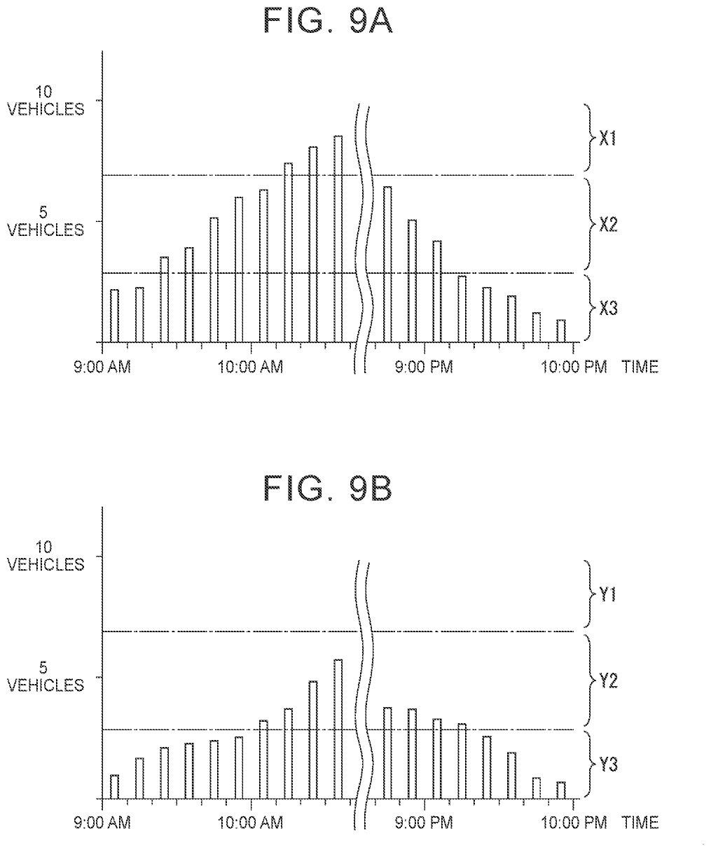

FIG. 9A shows a conceptual diagram of a predicted value of a 10-minute average value of the number of vehicles stopped at the same time at the platform 4. In the embodiment according to the present disclosure, this predicted value is obtained every 10 minutes between 9 am and 10:00 μm, and FIG. 9A shows only the predicted value in a very small part of the time zone between 9 am and 10:00 pm. Further, FIG. 9A shows the range of high congestion (X1), medium congestion (X2), and low congestion (X3). On the other hand, FIG. 9B shows a conceptual diagram of a predicted value of a 10-minute average value of the number of vehicles stopped at the same time at the platform 5. In the embodiment according to the present disclosure, this predicted value is obtained every 10 minutes between 9 am and 10:00 μm, and FIG. 9B shows only the predicted value in a very small part of the time zone between 9 am and 10:00 pm. Further, FIG. 9B shows the range of high congestion (Y1), medium congestion (Y2), and low congestion (Y3).

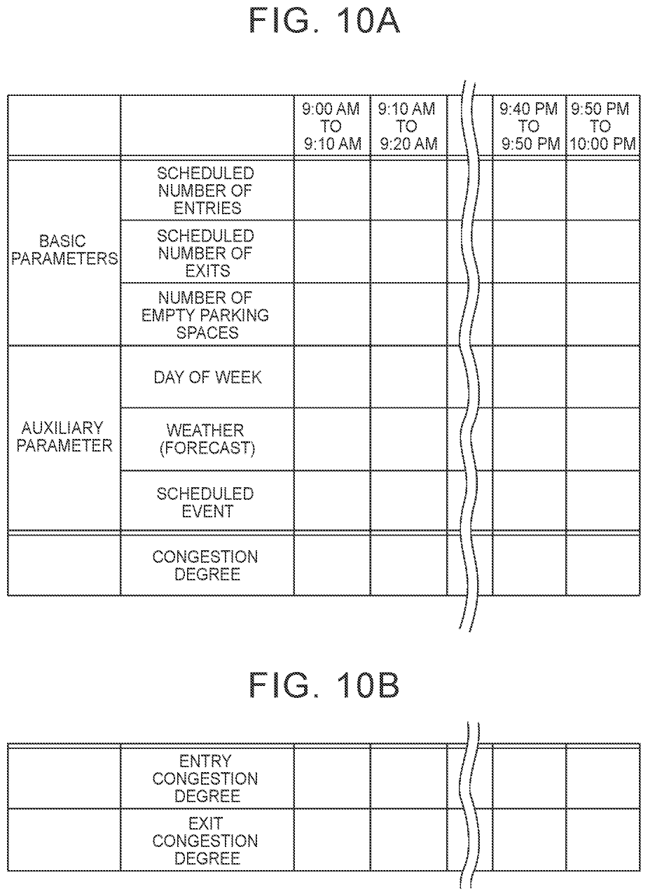

In the embodiment according to the present disclosure, the predicted values in FIGS. 9A and 9B are obtained by using a congestion degree prediction model created based on past data, and FIG. 10A shows is a data set for creating this prediction model. Referring to FIG. 10A, this dataset consists a list of basic parameters that directly affect the congestion degree, auxiliary parameters that have a large effect on the congestion degree, and the actual congestion degree every 10 minutes between 9 am and 10:00 μm. In this case, the planned number of entries, the planned number of exits, and the empty parking spaces per 10 minutes are used as the basic parameters that directly affect the congestion degree, and the day of the week, weather forecasts, and scheduled events are used as the auxiliary parameters that have a large effect on the congestion. In this case, in terms of the day of the week, for example, Sunday is set as 1, Monday is set as 2, and so on, in terms of the weather forecast, for example, sunny is set as 1, rain is set as 2, and so on, and in terms of the event, the large event is set as 1, a medium event is set as 2, and so on.

On the other hand, as the congestion degree in FIG. 10A, the actual congestion degree in each time zone is used. In this case, when the data set shown in FIG. 10A is a data set for creating a prediction model of the congestion degree of the platform 4, the congestion degree of FIG. 10A is set to be the actual congestion degrees X1, X2, or X3 of the platform 4 in each of the time zones. When the data set shown in FIG. 10A is a data set for creating a prediction model of the congestion degree of the platform 5, the congestion degree of FIG. 10A is set to be the actual congestion degrees Y1, Y2, or Y3 of the platform 5 in each of the time zones. The data set shown in FIG. 10A is created every day except for the parking lot closure days, and for example, a prediction model of the congestion degree of the platform 4 and a prediction model of the congestion degree of the platform 5 are created using the data set for the past year.

In this case, in the embodiments according to the present disclosure, these prediction models are created by using the neural network shown in FIG. 11. In FIG. 11, L=1 indicates an input layer, L=2 and L=3 indicate a hidden layer, L=4 indicates an output layer, and SM indicates a softmax layer. When creating a prediction model of the congestion degree of the platform 4 between the time of 9:00 am and 9:10 am in FIG. 10A, first, for example, the number of scheduled entries, the number of scheduled exits, empty parking spaces, the day of the week, weather forecasts, and scheduled events from 9:00 am to 9:10 am of the oldest dated dataset are input to each of the nodes of the input layer L=1 as shown in FIG. 11. When the congestion degree of this data set is X2 for example, an error back propagation method is used to perform learning of weight of the neural network so that X2 shown in FIG. 11 becomes 1 (correct label).

After learning of weight of the neural network from 9:00 am to 9:10 am for the oldest dated dataset, then, for example, the number of scheduled entries, the number of scheduled exits, empty parking spaces, the day of the week, weather forecasts, and scheduled events from 9:00 am to 9:10 am of the next oldest dated dataset are input to each of the nodes of the input layer L=1 as shown in FIG. 11, and when the congestion degree of this data set is X1 for example, an error back propagation method is used to perform learning of weight of the neural network so that X1 shown in FIG. 11 becomes 1 (correct label). In this way, when the learning of weight of the neural network from 9:00 am to 9:10 am of the data sets of the past year is completed, the learned neural network creates the prediction model of the congestion degree of the platform 4 from 9:00 am to 9:10 am.

Similarly, the prediction model of the congestion degree of the platform 4 from the time 9:10 am to 9:20 am, the prediction model of the congestion degree of the platform 4 from the time 9:20 am to 9:30 am, . . . the prediction model of the congestion degree of the platform 4 from the time 9:40 μm to 9:50 μm, and the prediction model of the congestion degree of the platform 4 from the time 9:50 μm to 10:00 pm. Further, the prediction model of the congestion degree of the platform 5 from the time 9:00 am to 9:10 am, the prediction model of the congestion degree of the platform 5 from the time 9:10 am to 9:20 am, the prediction model of the congestion degree of the platform 5 from the time 9:20 am to 9:30 am, . . . the prediction model of the congestion degree of the platform 5 from the time 9:40 μm to 9:50 μm, and the prediction model of the congestion degree of the platform 5 from the time 9:50 μm to 10:00 μm. The number of scheduled entries, the number of scheduled exits, the empty parking spaces, the day of the week, the weather forecast, and the scheduled event are constantly updated and stored in the memory 43 of the electronic control unit 40 of the exit control server 8.

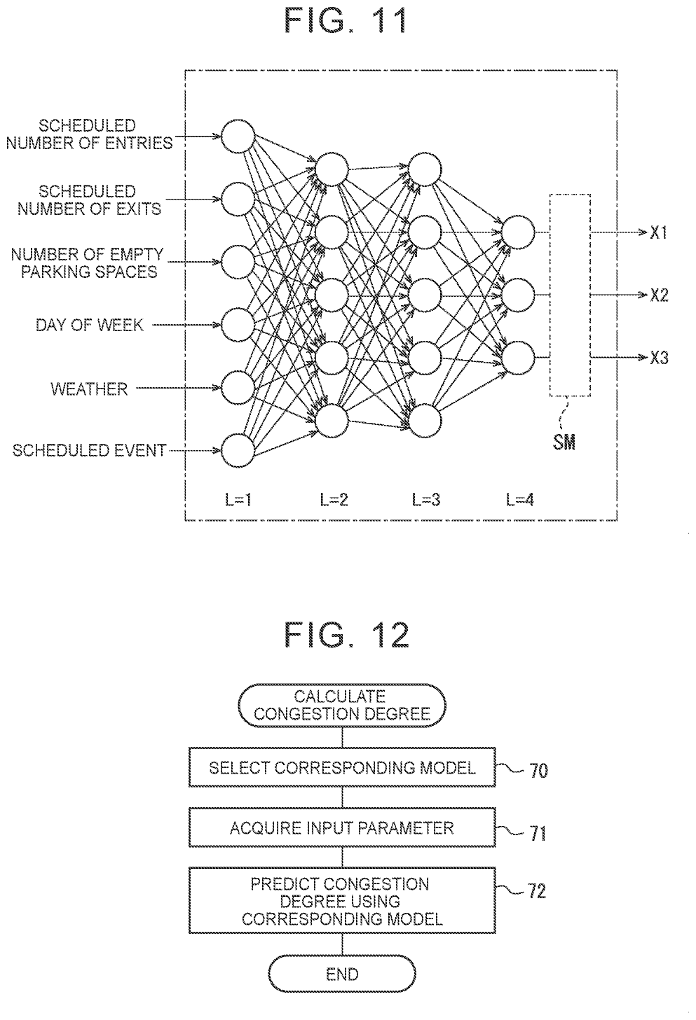

FIG. 12 shows a routine for calculating the congestion degree when there is an entry-exit request from the user, by using the prediction model of the congestion degree during each of these times. This routine is executed in the electronic control unit 40 of the entry-exit control server 8. Referring to FIG. 12, first, in step 70, the prediction model corresponding to the entry-exit request from the user is selected based on the entry-exit time zone specified by the user and the platform requested to be used. For example, assuming that the platform requested to be used by the user is the platform 4, the prediction model of the congestion degree of the platform 4 at the entry time specified by the user and the prediction model of the congestion degree of the platform 4 at the exit time specified by the user are selected.

Next, in step 71, the input parameters for the platform 4 stored in the memory 43 of the electronic control unit 40 of the exit control server 8, that is, the input parameter at the entry time specified by the user and the input parameter at the exit time specified by the user are acquired from the estimated number of entries, the estimated number of exits, the empty parking spaces, the day of the week, the weather forecast, and the scheduled events. Next, in step 72, by using the prediction model of the congestion degree of the platform 4 at the entry time specified by the user and the prediction model of the congestion degree of the platform 4 at the exit time specified by the user, by inputting the acquired corresponding input parameters into these prediction models, the congestion degree of the platform 4 at the entry time specified by the user and the congestion degree of the platform 4 at the exit time specified by the user are predicted.

Similarly, even when the user requests to use the platform 5, the congestion degree of the platform 5 at the entry time specified by the user and the congestion degree of the platform 5 at the exit time specified by the user specify can be estimated by using the calculation routine shown in FIG. 12. Further, when the boarding places 4a and 5a and the alighting places 4b and 5b are installed independently, the estimation model of the exit congestion degree of the boarding places 4a and 5a and the estimation model of the entry congestion degree of the alighting places 4b and 5b can be separately created so that the exit congestion degree and the entry congestion degree can be separately estimated by using the prediction model of the entry congestion degree and the prediction model of the entry congestion degree. In this case, instead of the data set shown in FIG. 10A, a data set in which the congestion degree of the data set of FIG. 10A is replaced with the entry congestion degree and the exit congestion degree shown in FIG. 10B is used. Thus, in the embodiments according to the present disclosure, the congestion degree is predicted based on the scheduled number of entries and exits per unit time and the day of the week in the least.

As a practical matter, there is a case in which the platform requested to be used is extremely crowded in the entry-exit time zone specified by the user, and the actual entry-exit time zone is significantly delayed from the entry-exit time zone specified by the user. For example, there is a case in which the user has specified the platform 4 as the platform, but the estimated congestion degree of the platform 4 is large in the entry-exit time zone specified by the user, and as a result, the actual entry-exit time zone is significantly delayed from the entry-exit time zone. In this case, as one method, it is conceivable to propose to the user to change the entry-exit time zone specified by the user to the entry-exit time zone with a low congestion degree. However, in this case, the user needs to change the schedule, and from the user's point of view, it is preferable that the entry-exit time zone specified by the user can be maintained.

On the other hand, there is a case in which there is another platform near the platform requested to be used, and the congestion degree of this other platform is low in the entry-exit time zone specified by the user. For example, there is a case in which in the entry-exit time zone specified by the user, the estimated congestion degree of the platform 4 requested to be used is large but the estimated congestion degree of the platform 5 is small. In this case, it is considered that there are many users who will appreciate it more to use the platform 5 without having to change the schedule.

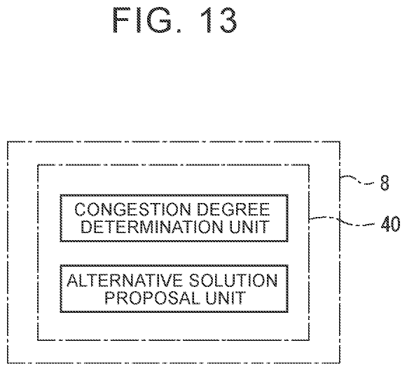

Thus, in the embodiment according to the present disclosure, as shown in the functional configuration diagram of the embodiment according to the present disclosure in FIG. 13, An automatic entry-exit system comprising an entry-exit control server 8 that controls entry and exit so as to provide an automatic parking service that causes a vehicle 20 that has arrived at a platform 4, 5 to enter one parking space 6 among a plurality of parking spaces 6 by autonomous driving and that causes the vehicle 20 parked in the parking space 6 exit the platform 4, 5 by autonomous driving, the automatic entry-exit system includes a plurality of the platforms 4, 5, and the entry-exit control server 8 includes a congestion degree determination unit that determines a congestion degree of a platform 4, 5 requested to be used in an entry-exit time zone specified by a user that uses the automatic parking service when an entry-exit request in which one platform 4, 5 among the plurality of platforms 4, 5 is used is received from the user, and an alternative solution proposal unit that proposes another platform 4, 5 among the plurality of platforms 4, 5 when the congestion degree of the platform 4, 5 requested to be used is high, the other platform 4, 5 having a lower congestion degree than the platform 4, 5 requested to be used. In this case, the electronic control unit 40 of the entry-exit control server 8 forms the congestion degree determination unit and the alternative solution proposal unit.

Further, according to the present embodiment, provided is an automatic entry-exit method that controls entry and exit so as to provide an automatic parking service that causes a vehicle 20 that has arrived at a platform 4, 5 to enter one parking space 6 among a plurality of parking spaces 6 by autonomous driving and that causes the vehicle 20 parked in the parking space 6 exit the platform 4, 5 by autonomous driving, in which the automatic entry-exit method determines a congestion degree of a platform 4, 5 requested to be used in an entry-exit time zone specified by a user that uses the automatic parking service when an entry-exit request in which one platform 4, 5 among the plurality of platforms 4, 5 is used is received from the user, and in which the automatic entry-exit method proposes another platform 4, 5 among the plurality of platforms 4, 5 when the congestion degree of the platform 4, 5 requested to be used is high, the other platform 4, 5 having a lower congestion degree than the platform 4, 5 requested to be used.

Further, according to the present embodiment, provided is a program that controls entry and exit so as to provide an automatic parking service that causes a vehicle 20 that has arrived at a platform 4, 5 to enter one parking space 6 among a plurality of parking spaces 6 by autonomous driving and that causes the vehicle 20 parked in the parking space 6 exit the platform 4, 5 by autonomous driving, in which the program causes a computer to function so as to determine a congestion degree of a platform 4, 5 requested to be used in an entry-exit time zone specified by a user that uses the automatic parking service when an entry-exit request in which one platform 4, 5 among the plurality of platforms 4, 5 is used is received from the user, and propose another platform 4, 5 among the plurality of platforms 4, 5 when the congestion degree of the platform 4, 5 requested to be used is high, the other platform 4, 5 having a lower congestion degree than the platform 4, 5 requested to be used. The program is stored in a storage medium.

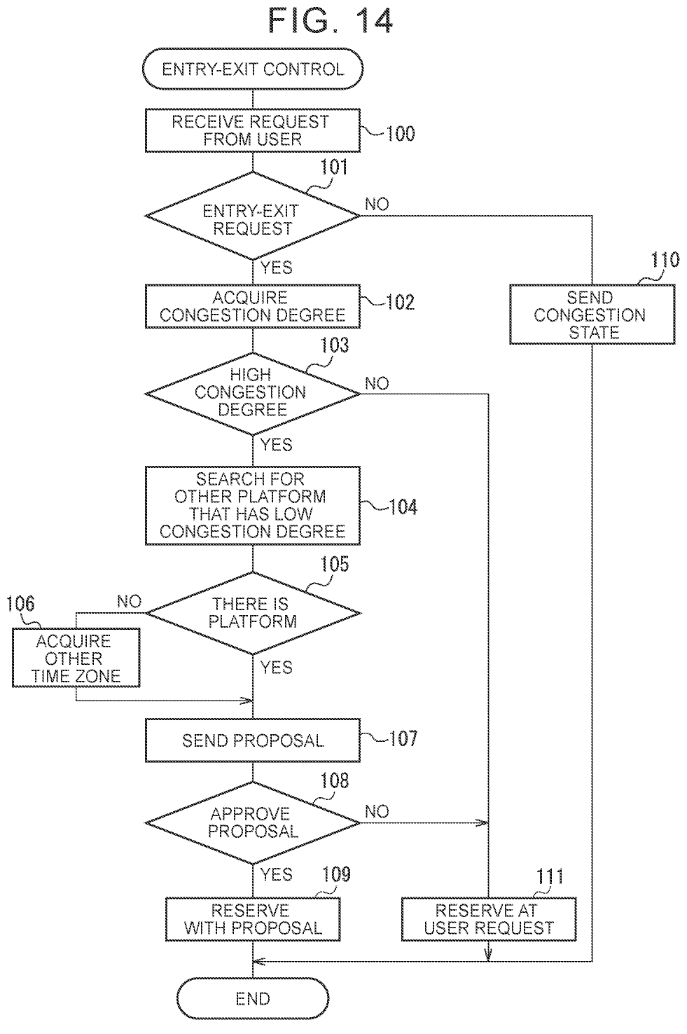

Next, one embodiment of the entry-exit control routine will be described with reference to FIG. 14. This routine is executed in the electronic control unit 40 of the entry-exit control server 8. Referring to FIG. 14, first, in step 100, a request from a user who uses the automatic parking service is received. Next, in step 101, it is determined whether the request received from the user is an entry-exit request or a viewing request of the entry-exit congestion degree status. When it is determined that the request received from the user is the viewing request of the entry-exit congestion degree status, the process proceeds to step 110, and the entry-exit congestion degree status is transmitted to the user.

That is, in the entry-exit control server 8, the predicted values X1, X2, and X3 of the congestion degree of the platform 4 for every 10 minutes and the predicted values Y1, Y2, and Y3 of the congestion degree of the platform 5 for every 10 minutes are calculated, the calculated predicted values X1, X2, and X3 of the congestion degree of the platform 4 for every 10 minutes and the calculated predicted values Y1, Y2, and Y3 of the congestion degree of the platform 5 for every 10 minutes are stored in the memory 43 of the electronic control unit 40 of the entry-exit control server 8. In step 110, the predicted values X1, X2, and X3 of the congestion degree of the platform 4 for every 10 minutes and the predicted values Y1, Y2, and Y3 of the congestion degree of the platform 5 for every 10 minutes that are stored in the memory 43 of the electronic control unit 40 of the entry-exit control server 8 are transmitted to the user.

On the other hand, in step 101, when it is determined that the request received from the user is the entry-exit request, the process proceeds to step 102, and among the predicted values X1, X2, and X3 of the congestion degree of the platform 4 for every 10 minutes and the predicted values Y1, Y2, and Y3 of the congestion degree of the platform 5 for every 10 minutes that are stored in the memory 43 of the electronic control unit 40 of the entry-exit control server 8, Based on the platform requested to be used and the entry-exit time zone specified by the user, the estimated value of the congestion degree of the platform requested to be used in the entry time specified by the user (hereinafter referred to as a specified entry time), and the estimated value of the congestion degree of the platform requested to be used in the exit time specified by the user (hereinafter referred to as a specified exit time) are acquired. Hereinafter, in order to easily understand the present disclosure, the entry-exit control routine will be described with a case in which the platform requested to be used is the platform 4 being an example. In this case, in step 102, the predicted value of the congestion degree of the platform 4 at the specified exit time and the predicted value of the congestion degree of the platform 4 at the specified entry time are acquired.

Next, in step 103, it is determined whether the predicted value of the congestion degree of the platform 4 at the specified entry time is the congestion degree X1, and whether the predicted value of the congestion degree of the platform 4 at the specified exit time is the congestion degree X1, for example. When it is determined that the predicted value of the congestion degree of the platform 4 at the specified entry time is not the congestion degree X1, that is, when the predicted value is determined to be the congestion degree X2 or X3, and when it is determined that the predicted value of the congestion degree of the platform 4 at the specified exit time is not the congestion degree X1, that is, when the predicted value is determined to be the congestion degree X2 or X3, the process proceeds to step 111, and the platform 4 requested to be used and the entry-exit time zone specified by the user are reserved.

On the other hand, in step 103, when it is determined that the predicted value of the congestion degree of the platform 4 at the specified entry time is the congestion degree X1, the process proceeds to step 104, and in the specified entry time, when the other platform that has a low congestion degree such as the congestion degree being X2 or X3, in the example shown in FIGS. 1 and 2, the platform 5 is searched. On the other hand, in step 103, when it is determined that the predicted value of the congestion degree of the platform 4 at the specified exit time is the congestion degree X1, the process proceeds to step 104, and in the specified exit time, the other platform that has a low congestion degree such as the congestion degree being X2 or X3 is searched. Further, in step 103, when it is determined that the predicted value of the congestion degree of the platform 4 at the specified entry time and the specified exit time is the congestion degree X1, the process proceeds to step 104, and in the specified entry time and the specified exit time, the other platform that has a low congestion degree such as the congestion degree being X2 or X3 is searched. Next, in step 105, it is determined whether there is another platform having the congestion degree of X2 or X3. In this case, in the examples shown in FIGS. 1 and 2, it is determined that there is the platform 5. When it is determined that there is the other platform 5 having a congestion degree of X2 or X3, the process proceeds to step 107, and in one or both of the specified entry time and the specified exit time, the proposal of using the other platform 5 is sent to the mobile terminal 46 of the user.

On the other hand, when it is determined that there is no other platform having the congestion degree of X2 or X3, the process proceeds to step 106, the other entry time or the other exit time in which the congestion degree of the platform 4 is X2, or X3 is acquired from the prediction values X1, X2, and X3 of the platform 4 for every 10 minutes stored in the memory 43 of the electronic control unit 40 of the entry-exit control server 8. Then, the process proceeds to step 107, and the proposal of using the other entry time or the other exit time is sent to the mobile terminal 46 of the user.

Then, in step 108, it is determined whether the user has approved the proposal. When it is determined that the user does not approve the proposal, the process proceeds to step 111, and the platform 4 requested to be used and the entry-exit time zone specified by the user are reserved. However, in this case, the actual entry-exit time is usually delayed significantly from the specified entry-exit time zone. On the other hand, when it is determined in step 108 that the user has approved the proposal, the process proceeds to step 109, and the reservation is made for the proposed platform or the proposed entry-exit time.

As described above, in this embodiment, when the predicted congestion degree of the platform 4 requested to be used at the designated entry time is high, the user is proposed to use the other platform 5 at the entry time. When the predicted congestion degree of the platform 4 requested to be used at the designated exit time is high, the user is proposed to use the other platform 5 at the exit time. When the predicted congestion degree of the platform 4 requested to be used at both the specified entry time and the specified exit time is high, the user is proposed to use the other platform 5 at the entry-exit time. In this case, when the congestion degree of the other platform 5 is high, the alternative solution proposal unit proposes the other entry-exit time zone in which the congestion degree of the platform 4 requested to be used is low.

On the other hand, in the entry-exit control routine shown in FIG. 14, entry and exit are managed and controlled. However, entry and exit can be managed and controlled individually. In this case, when only the entry is managed and controlled, only the entry can be managed and controlled by using the same routine as the entry-exit control routine shown in FIG. 14. Further, when only the exit is managed and controlled, only the exit can be managed and controlled by using the same routine as the entry-exit control routine shown in FIG. 14.

In the embodiment according to the present disclosure, when only the entry is managed and controlled, the congestion degree of the platform 4 requested to be used in the entry time zone specified by the user that uses the automatic parking service is determined, when the entry request in which one platform 4 among the plurality of platforms 4, 5 is used is received from the user, and the other platform 5 is proposed among the plurality of platforms 4, 5 when the congestion degree of the platform 4 requested to be used is high, the other platform 5 having a lower congestion degree than the platform 4 requested to be used. In this case, the platforms 4 and 5 may be the alighting places 4b and 5b.

Further, in the embodiment according to the present disclosure, when only the exit is managed and controlled, the congestion degree of the platform 4 requested to be used in the exit time zone specified by the user that uses the automatic parking service is determined, when the exit request in which one platform 4 among the plurality of platforms 4, 5 is used is received from the user, and the other platform 5 is proposed among the plurality of platforms 4, 5 when the congestion degree of the platform 4 requested to be used is high, the other platform 5 having a lower congestion degree than the platform 4 requested to be used. In this case, the platforms 4 and 5 may be boarding places 4a and 5a.

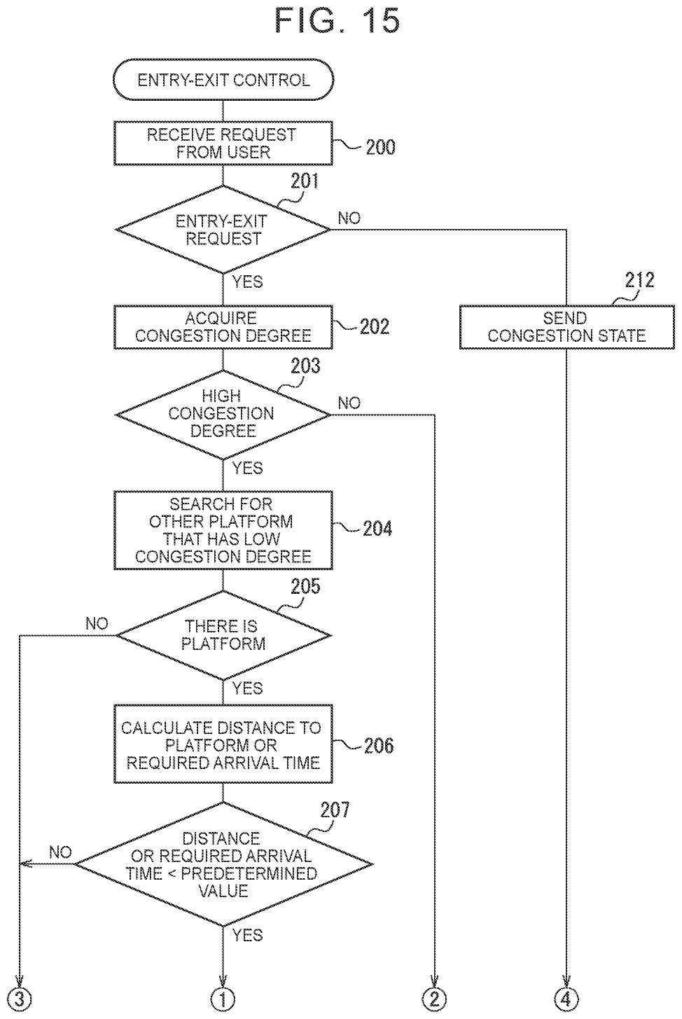

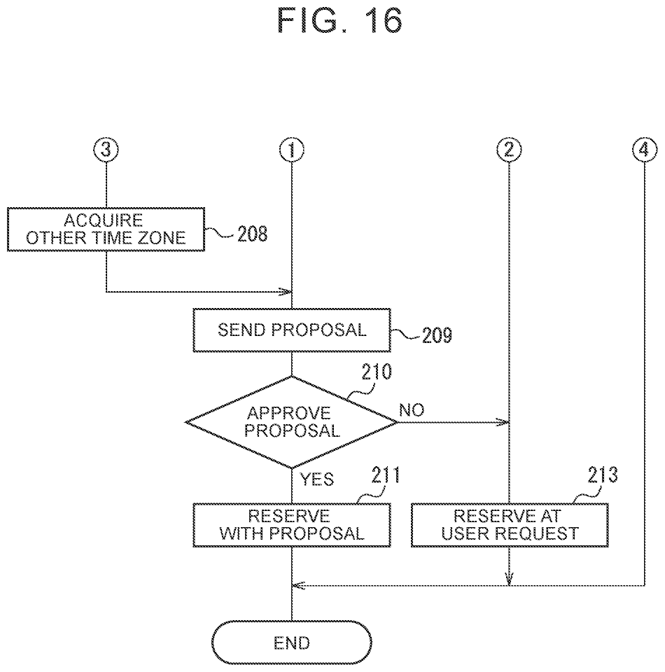

Next, another embodiment of the entry-exit control routine will be described with reference to FIGS. 15 and 16. This routine is also executed in the electronic control unit 40 of the entry-exit control server 8.

Referring to FIGS. 15 and 16, first of all, in step 200, a request from a user who uses the automatic parking service is received. Next, in step 101, it is determined whether the request received from the user is an entry-exit request or a viewing request of the entry-exit congestion degree status. When it is determined that the request received from the user is the viewing request of the entry-exit congestion degree status, the process proceeds to step 112, and the predicted values X1, X2, and X3 of the congestion degree of the platform 4 for every 10 minutes and the predicted values Y1, Y2, and Y3 of the congestion degree of the platform 5 for every 10 minutes that are stored in the memory 43 of the electronic control unit 40 of the entry-exit control server 8 are transmitted to the user.

On the other hand, in step 201, when it is determined that the request received from the user is the entry-exit request, the process proceeds to step 202, and among the predicted values X1, X2, and X3 of the congestion degree of the platform 4 for every 10 minutes and the predicted values Y1, Y2, and Y3 of the congestion degree of the platform 5 for every 10 minutes that are stored in the memory 43 of the electronic control unit 40 of the entry-exit control server 8, based on the platform requested to be used and the entry-exit time zone specified by the user, the estimated value of the congestion degree of the platform requested to be used in the entry time specified by the user and the estimated value of the congestion degree of the platform requested to be used in the exit time specified by the user are acquired. In this case as well, when the case in which the platform requested to be used is the platform 4 is described as an example, in step 202, the predicted value of the congestion degree of the platform 4 at the entry time specified by the user and the predicted value of the congestion degree of the platform 4 at the exit time specified by the user are acquired.

Next, in step 203, it is determined whether the predicted value of the congestion degree of the platform 4 at the specified entry time specified by the user is the congestion degree X1, and whether the predicted value of the congestion degree of the platform 4 at the specified exit time specified by the user is the congestion degree X1, for example. When it is determined that the predicted value of the congestion degree of the platform 4 at the specified entry time is not the congestion degree X1, that is, when the predicted value is determined to be the congestion degree X2 or X3, and when it is determined that the predicted value of the congestion degree of the platform 4 at the specified exit time is not the congestion degree X1, that is, when the predicted value is determined to be the congestion degree X2 or X3, the process proceeds to step 213, and the platform 4 requested to be used and the entry-exit time zone specified by the user are reserved.

On the other hand, in step 203, when it is determined that the predicted value of the congestion degree of the platform 4 at the specified entry time is the congestion degree X1, the process proceeds to step 204, and in the specified entry time, the other platform that has a low congestion degree such as the congestion degree being X2 or X3 is searched. In this case, in the examples shown in FIGS. 1 and 2, the platform 5 is searched. On the other hand, in step 203, when it is determined that the predicted value of the congestion degree of the platform 4 at the specified exit time is the congestion degree X1, the process proceeds to step 204, and in the specified exit time, the other platform that has a low congestion degree such as the congestion degree being X2 or X3 is searched. Further, in step 203, when it is determined that the predicted value of the congestion degree of the platform 4 at the specified entry time and the specified exit time is the congestion degree X1, the process proceeds to step 204, and in the specified entry time and the specified exit time, the other platform that has a low congestion degree such as the congestion degree being X2 or X3 is searched. Next, in step 205, it is determined whether there is another platform having the congestion degree of X2 or X3. In this case, in the examples shown in FIGS. 1 and 2, it is determined that there is the platform 5. When it is determined that there is the other platform 5 having the congestion degree of X2 or X3, the process proceeds to step 206.

In step 206, the distance from the user's existing position to the other platform, that is, the platform 5, or the required arrival time it takes for the user to reach the other platform, that is, the platform 5, is calculated. In this case, the user's existing position is estimated from, for example, the destination (for example, the facility 1) registered in the entry-exit control server 8 at the time of reservation, and the user's existing position is estimated from the position information of the user's mobile terminal 46 when there is the exit request. Next, in step 207, it is determined whether the distance from the user's existing position to the other platform 5 or the required arrival time it takes for the user to reach the other platform 5 is within a predetermined value. When it is determined that the distance or the required arrival time is within the predetermined value, the process proceeds to step 209, and in one or both of the specified entry time and the specified exit time, the proposal of using the other platform 5 is sent to the mobile terminal 46 of the user.

On the other hand, in step 205, when it is determined that there is no other platform having the congestion degree of X2 or X3, or in step 207, when it is determined whether the distance from the user's existing position to the other platform 5 or the required arrival time it takes for the user to reach the other platform 5 is equal to or more than the predetermined value, the process proceeds to step 208, and the other entry time zone or the other exit time zone in which the congestion degree of the platform 4 is X2 or X3 is acquired from the prediction values X1, X2, and X3 of the platform 4 for every 10 minutes stored in the memory 43 of the electronic control unit 40 of the entry-exit control server 8. Then, the process proceeds to step 209, and the proposal of using the other entry time zone or the other exit time zone is sent to the mobile terminal 46 of the user.

Then, in step 210, it is determined whether the user has approved the proposal. When it is determined that the user does not approve the proposal, the process proceeds to step 213, and the platform 4 requested to be used and the entry time zone specified by the user are reserved. However, in this case, the actual entry-exit time is usually significantly delayed from the entry-exit time zone specified by the user. On the other hand, when it is determined in step 210 that the user has approved the proposal, the process proceeds to step 211, and the reservation is made for the proposed platform or the proposed entry-exit time.

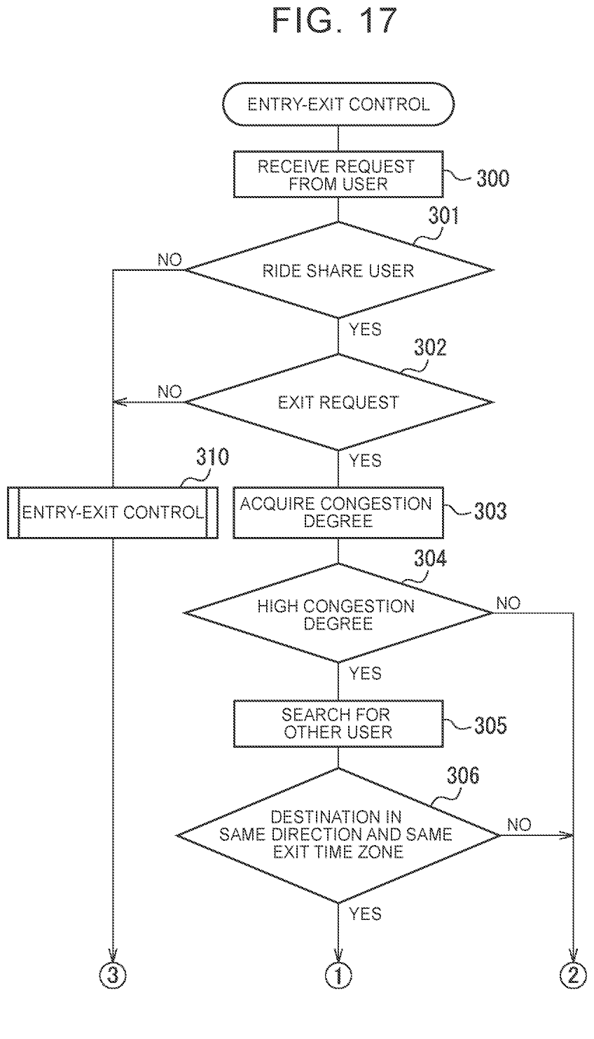

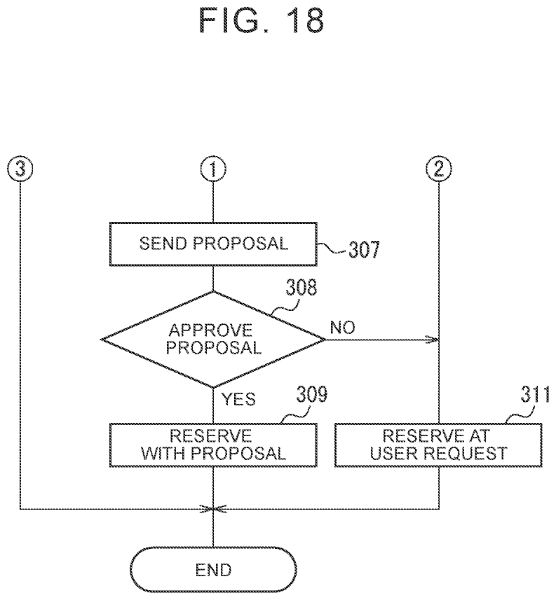

Next, still another embodiment of the entry-exit control routine will be described with reference to FIGS. 17 and 18. This routine is also executed in the electronic control unit 40 of the entry-exit control server 8. Referring to FIGS. 17 and 18, first of all, in step 300, the request from the user who uses the automatic parking service is received. In this case, the entry-exit request or the entry-exit congestion degree viewing request is received from the user. Further, in this embodiment, information regarding whether the user who uses the automatic parking service is using the ride sharing service by the autonomous driving share car or the autonomous driving taxi is received. Next, in step 301, it is determined whether the user who uses the automatic parking service is using the ride sharing service, and when it is determined that the user who uses the automatic parking service is not using the ride sharing service, the process proceeds to step 310, and the entry-exit control routine shown in FIG. 14 or the entry-exit control routine shown in FIGS. 15 and 16 is executed.

On the other hand, in step 301, when it is determined that the user who uses the automatic parking service is using the ride sharing service, the process proceeds to step 302, and it is determined whether the request from the user who uses the automatic parking service is the exit request. When it is determined that the request from the user who uses the automatic parking service is not the exit request, the process proceeds to step 310. On the other hand, when it is determined that the request from the user who uses the automatic parking service is the exit request, the process proceeds to step 303, and among the predicted values X1, X2, and X3 of the congestion degree of the platform 4 for every 10 minutes and the predicted values Y1, Y2, and Y3 of the congestion degree of the platform 5 for every 10 minutes that are stored in the memory 43 of the electronic control unit 40 of the entry-exit control server 8, the platform requested to be used in the exit time specified by the user such as the estimated value of the congestion degree of the platform 4 is acquired, based on the platform requested to be used and the exit time specified by the user.

Next, in step 304, it is determined whether the predicted value of the congestion degree of the platform 4 at the exit time specified by the user is, for example, the congestion degree X1. When it is determined that the predicted value of the congestion degree of the platform 4 at the exit time specified by the user is not the congestion degree X1, that is, when the predicted value is determined to be the congestion degree X2 or X3, the process proceeds to step 311, and the platform 4 requested to be used and the entry time specified by the user are reserved. On the other hand, in step 304, when it is determined that the predicted value of the congestion degree of the platform 4 at the exit time specified by the user is the congestion degree X1, the process proceeds to step 305, and from the reservation data stored in the memory 43 of the electronic control unit 40 of the entry-exit control server 8, the other user who uses the ride share service is searched.

Next, in step 306, it is determined whether the exit request that specifies the destination in the same direction and the same exit time zone is received from the user who made the exit request and the other user who is uses the ride sharing service. When it is determined that the exit request specifying the destination in the same direction and the same exit time zone is received from the other user and the user who made the exit request, the process proceeds to step 311, and the platform 4 requested to be used and the exit time zone specified by the user are reserved. However, in this case, the actual exit time is usually significantly delayed from the exit time zone specified by the user. In contrast, when it is determined that the exit request specifying the destination in the same direction and the same exit time zone is not received from the other user and the user who made the exit request, the process proceeds to step 307, and a proposal of carpooling is sent to the mobile terminal 46 of each of the users, the users being the other user and the user who made the exit request.

Then, in step 308, it is determined whether each of the users approves the proposal. When it is determined that each of the users do not approve the proposal, the process proceeds to step 311, and for each of the users, the platform requested to be used and the exit time zone specified by the user are reserved. However, in this case, the actual exit time is usually significantly delayed from the exit time zone specified by the user. On the other hand, when it is determined in step 308 that each of the users have approved the proposal, the process proceeds to step 309, and the proposed carpool is reserved.

That is, in this embodiment, in the automatic entry-exit system including the entry-exit control server 8 that controls entry and exit so as to provide the automatic parking service that causes the vehicle 20 that has arrived at the platform 4, 5 to enter one parking space 6 among the plurality of parking spaces 6 by autonomous driving and that causes the vehicle 20 parked in the parking space 6 exit the platform 4, 5 by autonomous driving, the entry-exit control server 8 includes the congestion degree determination unit that determines the congestion degree of the platform 4, 5 in the exit time zone in which exit requests in which destinations in the same direction and the same exit time zones are specified are received, when the exit requests are received from the plurality of users that uses the automatic parking service and the ride share service, and the alternative solution proposal unit that proposes carpooling to each of the users when the congestion degree of the platform 4, 5 is high.

What is claimed is:

1. An automatic entry-exit system comprising an entry-exit control server that controls entry and exit so as to provide an automatic parking service that causes a vehicle that has arrived at a platform to enter one parking space among a plurality of the parking spaces by autonomous driving and that causes the vehicle parked in the parking space to exit to the platform by autonomous driving,
wherein the automatic entry-exit system includes a plurality of the platforms, and
wherein the entry-exit control server includes
a congestion degree determination unit that determines a congestion degree of a platform requested to be used in an entry-exit time zone specified by a user that uses the automatic parking service, when an entry-exit request in which one platform among the plurality of the platforms is used is received from the user, and
an alternative solution proposal unit that proposes use of another platform among the plurality of the platforms when the congestion degree of the platform requested to be used is high, the other platform having a lower congestion degree than the platform requested to be used.

2. The automatic entry-exit system according to claim 1, wherein when the congestion degree of the other platform is high, the alternative solution proposal unit proposes another entry-exit time zone in which the congestion degree of the platform requested to be used is low.

3. The automatic entry-exit system according to claim 1, wherein when the congestion degree of the platform requested to be used is high, the alternative solution proposal unit determines whether there is the other platform among the plurality of the platforms, the other platform having a lower congestion degree than the platform requested to be used, and when the alternative solution proposal unit determines that there is the other platform, the alternative solution proposal unit proposes use of the other platform to the user.

4. The automatic entry-exit system according to claim 3, wherein when the alternative solution proposal unit determines that there is the other platform among the plurality of the platforms, the other platform having a lower congestion degree than the platform requested to be used, the alternative solution proposal unit determines whether a distance from an existing position of the user to the other platform or a necessary arrival time the user takes to arrive at the other platform from the existing position of the user is within a predetermined value, and when the alternative solution proposal unit determines that the distance or the necessary arrival time is within the predetermined value, the alternative solution proposal unit proposes use of the other platform to the user.

5. The automatic entry-exit system according to claim 1, wherein the congestion degree determination unit determines a congestion degree of a platform requested to be used in an entry time specified by the user that uses the automatic parking service, when an entry request in which one platform among the plurality of the platforms is used is received from the user, and wherein the alternative solution proposal unit proposes use of the other platform among the plurality of the platforms when the congestion degree of the platform requested to be used is high, the other platform having a lower congestion degree than the platform requested to be used.

6. The automatic entry-exit system according to claim 5, wherein the platform is an alighting place.

7. The automatic entry-exit system according to claim 1, wherein the congestion degree determination unit determines the congestion degree of a platform in an exit time specified by the user that uses the automatic parking service, when an exit request in which one platform among the plurality of the platforms is used is received from the user, and wherein the alternative solution proposal unit proposes use of another platform among the plurality of the platforms when the congestion degree of the platform requested to be used is high, the other platform having a lower congestion degree than the platform requested to be used.

8. The automatic entry-exit system according to claim 7, wherein the platform is a boarding place.

9. The automatic entry-exit system according to claim 1, wherein the congestion degree is predicted based on at least scheduled numbers of entries and exits per unit time and a day of a week.

10. An automatic entry-exit system comprising an entry-exit control server that controls entry and exit so as to provide an automatic parking service that causes a vehicle that has arrived at a platform to enter one parking space among a plurality of the parking spaces by autonomous driving and that causes the vehicle parked in the parking space to exit to the platform by autonomous driving,
wherein the entry-exit control server includes
a congestion degree determination unit that determines, when exit requests specifying destinations in the same direction and the same exit time zone are received from a plurality of users that uses an automatic parking service and a ride share service, a congestion degree of the platform in the exit time zone for which the exit requests are received, and
an alternative solution proposal unit that proposes carpooling to each of the users when the congestion degree of the platform is high.

11. An automatic entry-exit method that controls entry and exit so as to provide an automatic parking service that causes a vehicle that has arrived at a platform to enter one parking space among a plurality of the parking spaces by autonomous driving and that causes the vehicle parked in the parking space to exit to the platform by autonomous driving, the automatic entry-exit method comprising:
determining a congestion degree of a platform requested to be used in an entry-exit time zone specified by a user that uses the automatic parking service, when an entry-exit request in which one platform among a plurality of the platforms is used is received from the user; and
proposing use of another platform among the plurality of the platforms when the congestion degree of the platform requested to be used is high, the other platform having a lower congestion degree than the platform requested to be used.

12. A non-transitory storage medium that stores a program for controlling entry and exit so as to provide an automatic parking service that causes a vehicle that has arrived at a platform to enter one parking space among a plurality of the parking spaces by autonomous driving and that causes the vehicle parked in the parking space to exit to the platform by autonomous driving, wherein the program causes a computer to function so as to
determine a congestion degree of a platform requested to be used in an entry-exit time zone specified by a user that uses the automatic parking service, when an entry-exit request in which one platform among a plurality of the platforms is used is received from the user, and
propose use of another platform among the plurality of the platforms when the congestion degree of the platform requested to be used is high, the other platform having a lower congestion degree than the platform requested to be used.
